(19) United States
(12) Patent Application Publication
(10) Pub. No.: US 2019/0390019 A1
(43) Pub. Date: Dec. 26, 2019

(54) Method for Production of Natural Super-Absorbent Materials

(71) Applicant: Lakehead University, Thunder Bay (CA)

(72) Inventors: Lew Christopher, Thunder Bay (CA); Md Nur Alam, Thunder Bay (CA)

(21) Appl. No.: 16/255,316

(22) Filed: Jan. 23, 2019

Related U.S. Application Data
(60) Provisional application No. 62/621,660, filed on Jan. 25, 2018.

(51) Int. Cl. C08J 3/075; C08J 3/24; B01J 20/26; C08B 11/02; C08B 1/06

(52) U.S. Cl. CPC C08J 3/075; C08J 3/242; B01J 20/267; B01J 2220/68; C08B 1/06; C08J 2301/28; C08B 11/02

(57) ABSTRACT

The present disclosure relates to a superabsorbent polymer gel derived from renewable and biodegradable materials such as carboxyalkyl cellulose (CAC). The CAC had a degree of substitution (DS) of 0.5<DS<1. The carboxyalkyl cellulose was partially or fully solubilized in alkaline solution and crosslinked with a crosslinker to yield a crosslinked polycarboxy-material with high Water Retention Value (WRV) of at least 118 g/g saline water (0.9% sodium chloride solution) and Centrifuge Retention Capacity (CRC) of at least 90 g saline water/g superabsorbent material.

### PRIOR APPLICATION INFORMATION

The instant application claims the benefit of U.S. Provisional Patent Application 62/621,660, filed Jan. 25, 2018 and entitled “METHOD FOR PRODUCTION OF NATURAL SUPER-ABSORBENT MATERIALS”, the contents of which are incorporated herein by reference in their entirety.

### BACKGROUND OF THE INVENTION

Most of the common superabsorbent materials used today are based on crosslinked synthetic polymers, in particular polyacrylic acid and its co-polymers with acrylamide. Superabsorbent polymers, also referred to as SAPs, are formed by either “solution polymerization” of the partially-neutralized acrylic acid or by “suspension polymerization”, which can absorb water several hundred times its weight. Such SAPs are made by crosslinking the carboxyl groups in the polymer by one or two crosslinkers. It is advantageous to replace the synthetic polymers with natural polymers due to their green features (e.g., sustainable, biodegradable and environmentally friendly). Natural polymers, such as superabsorbent cellulose-based materials, already exist on the market; however, in most cases they are produced by incorporating super-absorbing polymeric particles into the cellulosic fibers. These particles are either based on synthetic polymers, such as polyacrylates, sulfonated polystyrene, polyvinyl alcohol, etc., or on biodegradable polymers, such as carboxyalkyl cellulose, gum, carboxyalkyl starch, cellulose sulphate, etc. Furthermore, the superabsorbent efficiency of the natural products currently available on the market is inferior (10-100 g distilled water/g superabsorbent) to their synthetic polyacrylic counterparts (1,000 g/g superabsorbent).

### SUMMARY OF THE INVENTION

According to a first aspect of the invention, there is provided a method of preparing a superabsorbent material comprising: mixing a quantity of delignified cellulose with a carboxymethylating agent at about 40-70° C. for about 2-4 hours; adding an effective amount of an alkaline base or alkaline hydroxide, thereby activating hydroxyl groups of the cellulose such that the hydroxyl groups of the cellulose react with the carboxymethylating agent; and washing the reacted cellulose, thereby providing a superabsorbent material.

### BRIEF DESCRIPTION OF THE DRAWINGS

FIG. 1 provides an overview of the major processing steps in the production of superabsorbent hydrogels.

FIG. 2 demonstrates that the hydrogels have fast re-swelling properties and accordingly are reusable.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

The present disclosure relates to a superabsorbent polymer gel derived from renewable and biodegradable materials such as carboxyalkyl cellulose (CAC). The CAC had a degree of substitution (DS) of 0.5<DS<1. The carboxyalkyl cellulose was partially or fully solubilized in alkaline solution and crosslinked with a crosslinker to yield a crosslinked polycarboxy-material with high Water Retention Value (WRV) of at least 118 g/g saline water (0.9% sodium chloride solution) and Centrifuge Retention Capacity (CRC) of at least 90 g saline water/g superabsorbent material.

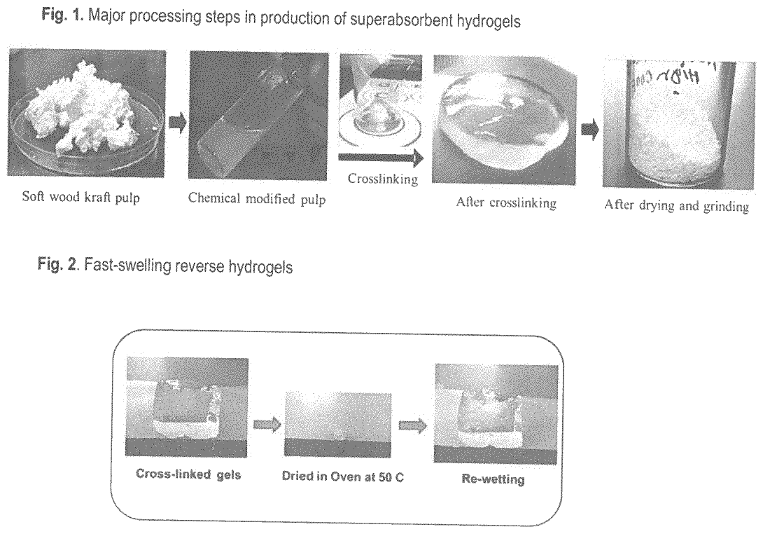

Specifically, as discussed herein, we have developed a new, aqueous-based, and environmentally-sound method for production of superabsorbent materials (FIG. 1). The process is catalyst-free and eco-friendly as the superabsorbent is derived from completely biodegradable polymers, with water as the only by-product. The main technical characteristics are summarized below.

In distilled water, the water retention value (WRV) of our hydrogels is in the range 600-900 g distilled water/g gel (Table 1), which is several times higher than any other cellulose-based superabsorbent material (10-100 g/g), and comparable to the commercial synthetic (polyacrylate) superabsorbent polymer (SAP) gels (˜1,000 g/g).

In saline water, the WRV of our hydrogel is 60-120 g saline water/g gel, which exceeds by more than 2-fold the WRV of commercial SAP materials (40-50 g/g).

As discussed herein, the superabsorbent hydrogels are produced from conventional bleached kraft pulps that contain up to 20% hemicellulose, which adds up to lower the production cost and increase the product yield.

Compared to commercial polyacrylate-based SAP, our newly developed hydrogels are “green” superabsorbents with several advantages over SAP. Specifically, they are biodegradable and are made from renewable materials with reduced carbon footprint.

Despite this, the hydrogels have superior liquid (saline) absorption properties over SAP and are also suitable for use in hygiene products as they are non-allergenic, have low odor and are completely reusable due to 100% retention of re-swelling property (fast reverse swelling after drying.

Accordingly, these hydrogels are suitable for applications in diverse industry sectors, including but not limited to hygiene, pharmaceutical, food and agricultural manufacturing.

According to an aspect of the invention, there is provided a method of preparing a superabsorbent material comprising:

mixing a quantity of delignified cellulose with a carboxymethylating agent at about 40-70° C. for about 2-4 hours;

adding an effective amount of an alkaline base or alkaline hydroxide, thereby activating hydroxyl groups of the cellulose such that the hydroxyl groups of the cellulose react with the carboxymethylating agent; and washing the reacted cellulose.

In some embodiments of the invention, the reacted cellulose is further reacted with a suitable crosslinking agent, thereby providing crosslinked superabsorbent material. As will be appreciated by one of skill in the art, a suitable crosslinking agent will be capable of crosslinking active groups of the reacted cellulose to one another.

As will be apparent to one of skill in the art, a wide variety of crosslinking agents may be used within the invention, depending on the desired effect on the reacted cellulose. For example, a crosslinking agent may be selected based on its molecular weight, its solubility in water and/or its reactivity.

Suitable crosslinking agents include for example but are by no means limited to epichlorohydrin, formaldehyde, divinylsulphone, chitosan, maleic acid anhydrite and the like.

It is noted that the specific conditions for carrying out the crosslinking reaction will depend on the nature of the crosslinking agent and the desired degree of crosslinking. It is of note that determination of suitable crosslinking conditions are consequently considered to be within the ambit of one skilled in the art.

In some embodiments, the crosslinking agent is added at about 1 to about 50 (wet) %, that is, of the aqueous solution.

In some embodiments, the delignified cellulose is a carboxyalkyl cellulose, for example, a carboxymethyl cellulose, a hydroxyethyl cellulose, a hydroxypropyl cellulose, a methyl cellulose, an ethyl cellulose or a combination thereof.

In some embodiments of the invention, the carboxyalkyl cellulose has a degree of substitution with carboxymethyl of between about 0.5 to about 1.0.

In some embodiments, the carboxyalkyl cellulose is a sodium carboxymethyl cellulose.

In some embodiments of the invention, the Centrifuge Retention Capacity of the crosslinked material is at least 90 g saline water and at least 600 g distilled water per g superabsorbent material

In some embodiments of the invention, the Water Retention Value (WRV) of the crosslinked material is at least 118 g saline water (0.9% NaCl solution) and at least 725 g distilled water per g of superabsorbent material.

As will be appreciated by one of skill in the art, while the carboxymethylating agent used in the examples is MCA, any suitable carboxymethylating agent known in the art may be used within the invention. Examples of suitable carboxymethylating agents include but are by no means limited to bromoacetic acid and fluoroacetic acid.

Furthermore, while sodium hydroxide is used as the alkaline base in the examples, any suitable alkaline base or alkaline hydroxide may be used within the invention, such as, for example, potassium hydroxide, aluminum hydroxide and lithium hydroxide.

While in the Examples, Kraft Pulp is used, other pulps including sulfite and dissolving pulps from both hardwood and softwood as well as other suitable sources of delignified cellulose may also be used within the invention.

In some embodiments of the invention, the reacted cellulose is washed with water, then washed with 80:20 ethanol:water and then washed with ethanol.

In some embodiments of the invention, the carboxymethylating agent is added at 1-2 parts (w/w) per 1 part (w/w) of the cellulose.

The invention will now be further explained and elucidated by way of examples; however, the invention is not necessarily limited by the examples.

### Example 1

The superabsorbent materials were prepared using a two-step process. In the first step, the cellulose fibers were reacted (carboxymethylated) in aqueous (water) medium using a modified carboxymethylation reaction. Air-dried, refined softwood kraft pulp was impregnated with a solution containing sodium monochloroacetate (MCA) in a Hobart mixer and transferred into a Nalgene bottle. MCA (200 g) was added to 100 g fiber in 260 g water. The suspension was agitated in a Hobart mixer for 10-15 min and then placed in a water bath preheated to 50° C. for 4 h to allow the MCA to thoroughly penetrate the fiber interior. After the steeping reaction, a solution of sodium hydroxide (NaOH) (125 g NaOH in 200 g water) was added to the reaction vessel and agitated for 10-15 min in the Hobart mixture. The reaction was let to proceed overnight (12 h). The pulp was then mixed with 4 volumes of water and centrifuged at 5,000 rpm for 10 min. After centrifugation, the supernatant was decanted and replaced by an excess amount of an ethanol/water (80/20 wt) mixture (which coagulates the fibers and makes it easier to recover and separate them by filtration) followed by filtration through 20 μm nylon mashes. The ethanol/water washing was repeated once more and then the fibers were washed with ethanol only. The product was subsequently washed with acetone twice and then air-dried. In this case, the carboxyl content of the reacted fibers was 3.3 mmol/g cellulose, as determined by a conductometric titration.

In the second step (crosslinking of carboxymethylated fibers), 3 g of air-dried, carboxymethyled fibers with a carboxyl group content of 3.3 mmol/g was added to 97 g of 6% NaOH solution in a 200 mL container to form a 3% cellulose solution in 6% NaOH. The suspension was stirred until the carboxymethylated fibers were fully dissolved. Thereafter, 4 g of epichlorohydrin (crosslinker) was slowly added to the solution of dissolved carboxymethylated fibers, and stirred at 100 rpm and room temperature for 1 h, until the viscous liquid turned into a highly viscous gel. The gel was then heated at 50° C. for 12 h to allow the carboxymethyl cellulose to crosslink. After the crosslinking reaction was completed, the crosslinked superabsorbent material was diced and immersed into excess of water. The water was replaced several times until the final conductivity reached a value of 700 ρS/cm. The crosslinked superabsorbent gel was dried in an oven at 50° C. and then grinded into a particle size of 400-600 um. The Water Retention Value (WRV) of the crosslinked gel was 118 g saline water (0.9% NaCl)/g superabsorbent. The Centrifuge Retention Capacity was 80 g saline water/g superabsorbent.

### Example 2

The first step for preparation of carboxymethylated fibers was as described in Example 1. In the second step, the feedstock for preparation of superabsorbent materials was a mixture of:1) air-dried, carboxymethylated fibers with 3.3 mmol carboxyl groups/g cellulose, prepared as described in Example 1, and 2) a high molecular weight (Mw ˜250,000) commercial sodium caboxymethyl cellulose (CMC) containing 5.4 mmol carboxyl groups/g CMC, purchased from Sigma-Aldrich. The two substrates were crosslinked as described in Example 1 at different CMC to carboxymethylated fiber ratios of 1:9, 1.5:8.5, and 2:8. The maximum WRV of the resultant superabsorbent material containing 15% CMC exceeded 95 g/g in saline solution at a CRC of 80 g/g.

The scope of the claims should not be limited by the preferred embodiments set forth in the examples but should be given the broadest interpretation consistent with the description as a whole.

TABLE 1
Water uptake comparison

| | WRV, g/g | WRV, g/g |
|---|---|---|
| | (distilled | (saline |
| Absorbent material | water uptake) | water uptake) |
| Commercial oil-based SAP | 1,000 | 40-50 |
| Raw cellulose pulp (control) | 2-10 | 1-5 |
| Modified cellulose pulp | 600-900 | 60-120 |
| (our natural SAP) | | |

1. A method of preparing a superabsorbent material comprising:
mixing a quantity of delignified cellulose with a carboxymethylating agent at about 40-70° C. for about 2-4 hours; adding an effective amount of an alkaline base or alkaline hydroxide, thereby activating hydroxyl groups of the cellulose such that the hydroxyl groups of the cellulose react with the carboxymethylating agent; and washing the reacted cellulose, thereby providing a superabsorbent material.

2. The method according to claim 1 wherein the reacted cellulose is further reacted with a suitable crosslinking agent.

3. The method according to claim 2 wherein the crosslinking agent is selected from the group consisting of epichlorohydrin, formaldehyde, divinylsulphone, chitosan, and maleic acid anhydrite.

4. The method according to claim 1 wherein the crosslinking agent is added to the reacted cellulose at about 1 to about 50%.

5. The method according to claim 1 wherein the cellulose is a carboxyalkyl cellulose.

6. The method according to claim 5 wherein the carboxyalkyl cellulose is selected from the group consisting of a carboxymethyl cellulose, a hydroxyethyl cellulose, a hydroxypropyl cellulose, a methyl cellulose, an ethyl cellulose and a combination thereof.

7. The method according to claim 6 wherein the carboxyalkyl cellulose is a carboxymethyl cellulose.

8. The method according to claim 7 wherein the carboxymethyl cellulose is a sodium carboxymethyl cellulose.

9. The method according to claim 5 wherein the carboxyalkyl cellulose has a degree of substitution of between about 0.5 to about 1.0.

10. The method according to claim 1 wherein the reacted cellulose is washed with water, then washed with 80:20 ethanol:water and then washed with ethanol.

11. The method according to claim 1 wherein the carboxymethylating agent is added at 1-2 parts (w/w) per 1 part (w/w) of the cellulose.
